(19) United States
(12) Patent Application Publication
(10) Pub. No.: US 2016/0019484 A1
(43) Pub. Date: Jan. 21, 2016

(54) SYSTEM AND METHOD FOR MANAGING RESOURCES OF A PROJECT

(71) Applicants: Anurag SRIVASTAVA, Bangalore (IN); Tekkethalakal KURIEN, Bangalore (IN)

(72) Inventors: Anurag SRIVASTAVA, Bangalore (IN); Tekkethalakal KURIEN, Bangalore (IN)

(73) Assignee: Wipro Limited., Bangalore (IN)

(21) Appl. No.: 14/501,123

(22) Filed: Sep. 30, 2014

(30) Foreign Application Priority Data
Jul. 18, 2014 (IN) 3550/CHE/2014

(51) Int. Cl. G06Q 10/06

(52) U.S. Cl. CPC G06Q 10/06313; G06Q 10/063118

(57) ABSTRACT

Systems and methods for managing resources in a project management model are described herein. In one embodiment, a computer-implemented resource management method is disclosed. The method comprises generating, for fulfilling a project specification, a resource allocation model indicative of at least one of: a hierarchical arrangement of a plurality of resource entities, or a competency index of one or more of the resource entities. One more project phases capable of being automated are identified by analyzing the project specification using one or more automation rules. The method includes initiating computational processing by a bot for automating the identified one or more project phases, and generating a modified workbench for at least one of the resource entities based on the resource allocation model and the identified one or more project phases.

### PRIORITY CLAIM

This U.S. patent application claims priority under 35 U.S.C. §119 to: India Application No. 3550/CHE/2014, filed Jul. 18, 2014, titled, “SYSTEM AND METHOD FOR MANAGING OPERATIONS OF A PROJECT.” The aforementioned application is incorporated herein by reference in their entirety for all purposes.

### TECHNICAL FIELD

The present subject matter relates to project management, and, particularly but not exclusively, to systems and methods for managing resources and operations in a project management model, including automated estimation, assignment, and configuration of computing resources, and initiation of computing processes.

### BACKGROUND

Organizations usually classify their business related activities into various projects. A project may be considered to include a collection of activities and tasks, which are designed to achieve a specific goal of an organization or of a client, with pre-defined performance or quality requirements, while meeting the constraints of time and cost. In industry practice, a project is usually allocated to a group of project personnel led by a project manager.

A project in an organization may have multiple stages, such as initiation; planning and design; execution and construction; monitoring and controlling; and completion. The techniques of project management usually involve planning, organizing, securing, and managing resources to achieve specific goals of the project. A project may be constrained by time, resources, and deliverables. Generally, project management techniques aim to achieve all of the project goals and objectives within constraints such as scope, time, and budget. The techniques of project management also generally aim to optimize the allocation and utilization of resources.

Project management usually includes project planning, wherein the scope of the project is estimated, the effort that may be involved in completing the project may be estimated, and a project schedule may be generated. The project planning also aims to ensure that all the requirements or expectations from the project are covered and usually generate a project plan, which depicts the various activities and tasks that may lead to completion of the project, within the constraints of time and resources. This planning is largely manual, with computers or pocket calculators being used mainly to perform rote calculations controlled by project planning personnel. The implementation of the plan and the progress of the project may be monitored at regular intervals so as to keep the various stakeholders updated on the project, and to ensure that the project does not deviate from the project plan. This project monitoring is also largely manual, may depend on a fair amount of human estimation, and is not systematic or algorithmic in nature.

### SUMMARY

Disclosed herein are systems and methods for managing resources in a project management model. In one embodiment, a resource management system is disclosed, comprising one or more hardware processors, and one or more memory units communicatively coupled to the one or more processors. The one or more memory units store processor-executable instructions, which, on execution, cause the one or more processors to perform acts including generating, for fulfilling a project specification, a resource allocation model indicative of at least one of: a hierarchical arrangement of a plurality of resource entities, or a competency index of one or more of the resource entities. The acts further include identifying one or more project phases capable of being automated, by analyzing the project specification using one or more automation rules. The acts also include initiating computational processing by a bot for automating the identified one or more project phases, and generating a modified workbench for at least one of the resource entities based on the resource allocation model and the identified one or more project phases.

In another embodiment, a computer-implemented resource management method is disclosed. The method comprises generating, for fulfilling a project specification, a resource allocation model indicative of at least one of: a hierarchical arrangement of a plurality of resource entities, or a competency index of one or more of the resource entities. One more project phases capable of being automated are identified by analyzing the project specification using one or more automation rules. The method includes initiating computational processing by a bot for automating the identified one or more project phases, and generating a modified workbench for at least one of the resource entities based on the resource allocation model and the identified one or more project phases.

In another embodiment, a non-transitory computer-readable medium storing computer-executable resource management instructions is disclosed, the instructions comprising instructions for performing the above method.

It is to be understood that both the foregoing general description and the following detailed description are exemplary and explanatory only and are not restrictive of the inventions, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number may identify the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1 illustrates a network environment implementing a project resources management system for managing resources in a project management model, according to some embodiments;

FIG. 2 illustrates an exemplary computer method for managing resources in a project management model, according to some embodiments;

FIG. 3 illustrates an exemplary computer implemented method for managing resources in a project management model, according to some embodiments; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods for managing resources in a project management model are described. The systems and methods may be implemented in a variety of computing systems. The computing systems that can implement the described method(s) include, but are not limited to: a server, a desktop personal computer, a notebook or a portable computer, a mainframe computer, and a mobile computing environment. Although the description herein is with reference to certain computing systems, the systems and methods may be implemented in other computing systems, albeit with a few variations, as will be understood by a person skilled in the art.

Organizations, for example, information technology (IT) organizations may classify their business related activities into various projects. A project is usually allocated to a group of project personnel. The project personnel may include professionals having varied expertise and competencies, such as business analysts, system architects, software developers, software testers, infrastructure experts, and database designers. The project personnel are usually headed by a project leader, and/or a project manager. The project manager may be understood to be a professional in the field of project management, having the responsibility of the planning, execution, and closing of any project. The projects, such as computer/mobile application development projects, infrastructure development & management projects, cloud based projects, research and development (R&D) projects, data analytics projects, system integration projects, business process outsourcing (BPO) projects, managed services projects, and chip designing projects, undertaken by organizations involve a myriad of tasks and activities that need to be completed in order to process the project through a requirement ascertaining stage, a planning stage, to a build/implementation stage, and subsequent approval and reporting stages.

For illustration, an organization involved in providing IT sales and services may undertake several projects for its clients. These projects may be varied in nature, for example, from building an online banking system for a financial institute to designing an e-commerce portal for an enterprise. Each of these projects may involve understanding the customer requirements of the clients or the business requirements of a client; translating these business requirements into technical requirements; allocating a team of experts or project members that can design software applications or infrastructure management to meet such technical requirements and so on. The technical requirements may be understood to be a set of user interfaces, business rules, report generation, etc., that the project personnel are to develop. Each of the aforementioned steps may be interdependent and important to ensure the successful completion of the project. For example, if the business requirements of the client are not completely captured or not accurately mapped to technical requirements, the project may need rework. This may not only involve extra man hours and overshooting of timelines and budgets, but also lead to dissatisfaction to the client.

Thus, the success of a project may be determined by how well the project is planned such that requirements of all the stakeholders are met without violating any constraint. In large IT organizations, numerous projects may be undertaken simultaneously. Effective management of these numerous projects can directly translate into profit for these IT organizations. In most cases, the tasks of the project are performed manually, which may result in a high volume of human resources allocated to each project. This may lead to higher costs as well as enhanced chances of human errors.

The present subject matter discloses systems and methods for managing resources in a project management model. In some embodiments, a project resource management (PRM) system, which is a computerized system, may implement the techniques of managing operations in a project management model, including automated estimation, assignment, and configuration of computing resources to improve the functioning of those computing resources and the overall utilization and functioning of the IT organization's computing resources, as well as automated initiation of computing processes (e.g., bots) on the auto-configured computing resources.

In operation, the PRM system obtains a project specification of a project from a client. The project specification may be understood to be a comprehensive description of objectives for the project. The project specification may include the goals, functionality, and details required for the project team to fulfill the requirements of the client. In this context, for example, the client may be understood to be a third party organization or a division of the organization itself, e.g., an internal client. In various examples, the project specification may be provided as an input to the PRM system or may be retrieved, from a data repository, by the PRM system.

The PRM system may analyze the project specification and generate a resource allocation model for fulfilling the project specification. In some embodiments, this may comprise an automated computing process, wherein the project specification may be provided in the form of structured data (e.g., having a pre-defined data model in XML or JSON format) or unstructured data (e.g., e-mail messages, webpages, word processing documents, photos, videos, presentations, or other business documents). In some embodiments, the resource allocation model may comprise a plurality of resource entities allocated to the project for fulfilling the project specification. These resource entities may be human resources or may be robotic resources, such as specially programmed computer, embedded systems, and bots. Bots may be understood to be software applications that operate as agents for a user or another software application, or simulates a human activity. For example, bots may be specialized software applications that execute automated tasks. In some examples, the resource allocation model may include indications of the hierarchical arrangement of a plurality of resource entities assigned to the project. For example, the resource allocation model may arrange the human resources into a plurality of levels, such as project engineers, senior project engineers, team leaders, project managers and so on. Each level of the human resources may be assigned, by the PRM system, a set of roles and responsibilities. In one example, the resource allocation model may generate the hierarchical arrangement of a plurality of resource entities based on a competency index, in some cases, calculated by the PRM system, associated with each of the resource entities. For example, in case of human resources, the resource allocation model may generate the competency index of the resource entity based on various competency parameters, such as domain knowledge, educational qualifications, years of experience, certifications, and project experience including project outcome assessments. As an example, to compute the competency index, the PRM system may assign a weightage parameter to each of the competency parameters and compute a weighted mean of the competency parameters as the competency index. In some examples, the weightage parameter of each of the competency parameters may be based on the organizational policies or may be decided by the project manager.

Similarly, in the case of robotic resources, the competency index may be based on various competency parameters, such as programming language of the robotic resource, platform of the robotic resource, domain to which the robotic resource pertains, algorithm efficiency of the robotic resource and the resource usage, in terms of processing power and memory space, of the of the robotic resource (e.g., number of processing threads required, number of processors engaged, number of clock cycles utilized, amount of energy consumed, extent of parallelization or distribution of the computation, amount of processor idle time in processing, amount of (virtual) memory utilized, etc.). The competency index of the resource entity may be indicative of the suitability of the resource entity, human or computational, in the project. In some examples, the PRM system may design the resource allocation model such that a role is assigned to at least one resource entity in the resource allocation model. For example, a first resource entity may be assigned as a tester, a second resource entity may be assigned as a lead developer, and so on. Thus, the resource allocation model may indicate a hierarchical arrangement of the resource entities which have been allocated or assigned to the project.

In a parallel or sequential operation, the PRM system may identify one or more phases of the project capable of being automated, based on analysis of the project specification. In one example, the PRM system may retrieve automation rules and execute them to identify the phases of the project that may be automated. As an illustration, in the case of the project specification being specified by unstructured data, the PRM system may parse the project specification using a parser compatible with the file type and data format, and identify key words or phrases in the project specification. Such identification of key words or phrases may utilize an electronic dictionary, as well as computer science techniques such as semantic or natural language processing. The PRM system may correlate such key words or phrases to attributes or fields in a pre-defined data model based on the automation rules, and convert the unstructured project specification data into a structured data set corresponding to a pre-defined data model, which may define the project in terms conducive to further automated processing, as explained below.

In one example, say the project pertains to infrastructure operations, which comprises the phases of service desk & dispatch, monitoring, second level (L2) escalation and advanced level (L3) escalation. In this infrastructure operations project, the PRM system may analyze the technical and business objectives and requirements of the different phases, and may identify that the service desk & dispatch may be automated, whereas the escalation levels may be assisted by robotic resources which will lead to lesser cycle time and higher success ratio of resolution of service tickets.

Thereafter, the PRM system may modify at least one or more portions of a workbench associated with a resource entity based on at least one of the resource allocation model, the assigned role, and the identified phases of the project. In some examples, workbench may be regarded as a tool used for scheduling and allocating tasks of a project to the assigned resource entities. For example, the PRM system may analyze the project specification and determine that the task of generating pseudo code may be automated and may be assigned to a bot. Based on the analysis, the PRM system may modify portions of the workbench, associated with a software engineer, to incorporate the automation of pseudo code generation in the work assigned to the software engineer. As non-limiting examples of workbench modification, the PRM system may change or modify the operating system executing on a computer (e.g., one utilized by a software engineer or by the bot), modify data and/or access privileges on or from the computer, install or uninstall programs including service components, utilities, widgets, and applications for execution on the computer, transfer data to or from the computer, modify control settings on the computer, initiate processes or applications executing on the computer, initiate monitoring of user or computing activity on the computer, set alarms or other thresholds on the computer, or the like.

In a parallel or sequential operation, the PRM system may ascertain the processes associated with the project based on analysis of the project specification. In some examples, the processes may be understood to be a collection of related, structured or unstructured activities or tasks that produce a specific service or product for fulfilling the project specification. In project management tools, the business processes may be visualized as a flowchart which has a sequence of activities with interleaving decision points or with a process matrix as a sequence of activities with relevant rules based on data in the process. The PRM system may identify those processes, from amongst the processes associated with the project, which have an effectiveness index less than a pre-defined threshold level. The effectiveness index of a process may be based on various parameters, such as the efficiency of the process, the resource utilization of the process, the output of the process, and the productivity of the process. Each of the parameters, effectiveness, efficiency, resource utilization, output, and productivity, may be defined according to a set of equations that take as input various measurable objective inputs. In the case of computational resources, such inputs may include, e.g., number of processing threads required, number of processors engaged, number of clock cycles utilized, amount of energy consumed, extent of parallelization or distribution of the computation, amount of processor idle time in processing, amount of (virtual) memory utilized, etc. In the case of human resources, such inputs may include, e.g., domain knowledge, educational qualifications, years of experience, certifications, and project experience. In some examples, the PRM system may monitor, at regular time intervals or on demand (e.g., by the project manager), whether the processes associated with the project have an effectiveness index that is equal to or greater than the pre-defined threshold level. If the PRM system determines that one or more processes have an effectiveness index less than the pre-defined threshold level, then the PRM system, either in an automated manner or based on inputs provided by the project manager, may apply process optimization techniques known in the art to amend the processes so as to enhance the effectiveness index of the automated processes above the pre-defined threshold level. In some examples, process optimization techniques implemented by the PRM system may be based on six-sigma techniques, lean process techniques, or a combination thereof.

Based on the amendment of the processes, the PRM system may modify one or more of the resource allocations, or modify one or more workbenches associated with the resource entities to implement the amended processes.

Thus, embodiments of the present disclosure describe systems and methods for managing resources in a project management model including identifying the phases of the project that may be automated. This may reduce the human resources which have to be associated with a project for fulfilling the project specification. This may in turn lead to lower costs of human resources, lowered probability of manual errors, and may ensure consistent quality across various processes of the project. Further, in some embodiments, the PRM system may monitor and identify the processes that are less effective than a pre-defined threshold level, and optimize the identified processes using process optimization so as to increase the effectiveness of the processes. This may lead to overall enhancement of efficiency and productivity of the project, including the technological resource (such as computers) utilized in the project, leading to lower costs, lower error rates, enhanced feedback, and higher profits.

In this regard, embodiments of the present disclosure can provide several technological improvements over conventional industrial practices. For example, the disclosed embodiments may facilitate estimation of hardware and software resources in a systematic, algorithmic fashion, as opposed to manual estimation or guesswork. Whereas conventionally, identical, redundant, and bloated computing hardware and software resources may have been assigned to each software engineer, other personnel, or the project generally, the disclosed embodiments may allow customization of computing resources assigned, on a project-by-project basis, and in an automated fashion based on criteria. Further, the disclosed embodiments may facilitate automated assignment of computing tasks to bots, or auto-configuration of the computing resources to incorporate the (pseudo-)code produced by the bots into the code being generated by the software engineer. Moreover, the disclosed embodiments may implement repeated re-calculation of objective effectiveness indices—which conventionally were not measured—and automated modification of the computing resources, computing processes, and hierarchy of human personnel, by adaptive learning techniques known in the computer science technical field, to increase such objective indices. These various technological improvements may improve the functioning of the computers themselves (as measured by criteria) involved in the computational processing, as well as the overall utilization and functioning of the IT organization's computing resources.

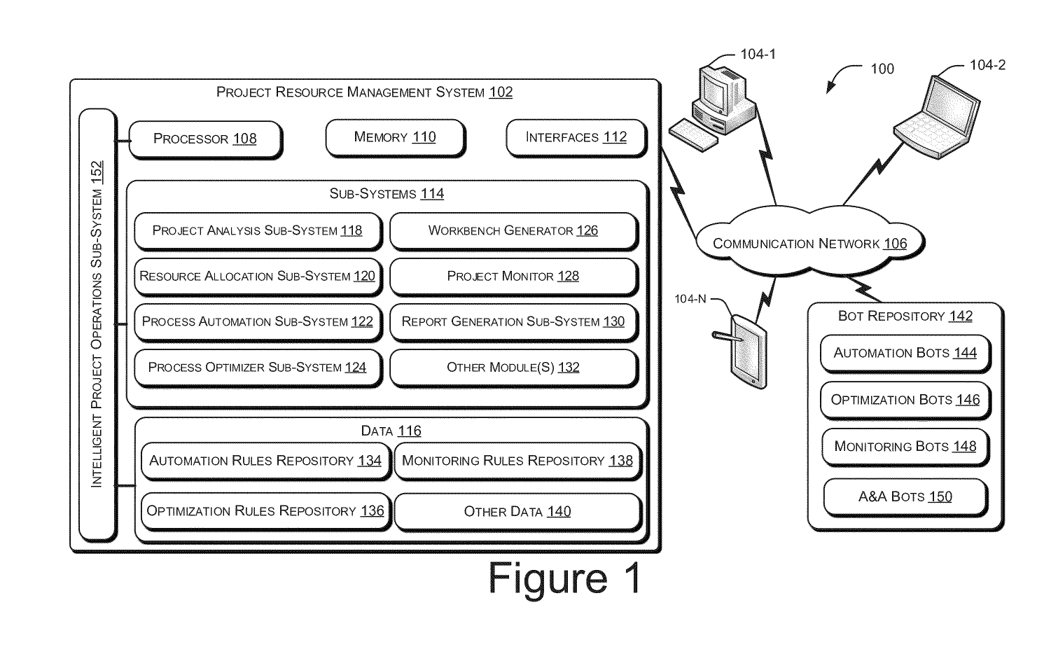

The working of the systems and methods for managing resources in a project management model is described in greater detail in conjunction with FIGS. 1-4. It should be noted that the description and drawings merely illustrate the principles of the present disclosure. It will thus be appreciated that those skilled in the art will be able to devise various arrangements that, although not explicitly described or shown herein, embody the principles of the present subject matter and are included within its spirit and scope. Furthermore, all examples recited herein are principally intended to be only for pedagogical purposes to aid the reader in understanding the principles of the present disclosure, and are not to be construed as limited to such specifically recited examples and conditions. Moreover, all statements herein reciting principles, aspects, and embodiments of the present disclosure, as well as specific examples thereof, are intended to encompass equivalents thereof. While aspects of the systems and methods can be implemented in any number of different computing systems environments, and/or configurations, the embodiments are described in the context of the following exemplary system architecture(s).

FIG. 1 illustrates a network environment 100 implementing a project resources management system 102, henceforth referred to as the PRM system 102, according to some embodiments of the present subject matter. In the embodiment, the network environment 100 may include the PRM system 102 configured for managing resources in a project management model. In one implementation, the PRM system 102 may be included within an existing information technology infrastructure of an organization or of a client or may be implemented in a cloud based computing structure. For example, the PRM system 102 may be interfaced with the existing content and document management system(s), database and file management system(s), of the organization. The PRM system 102 may be used for various types of projects, such as computer/mobile application development projects, infrastructure development & management projects, cloud based projects, research and development (R&D) projects, data analytics projects, system integration projects, business process outsourcing (BPO) projects, managed services projects, and chip designing projects, in various domains, such as banking and financial, telecommunications, healthcare, fast moving consumer goods (FMCG), retail and energy sector. It should be appreciated that an organization may be simultaneously involved in multiple projects, which may be pertaining to one or more different domains. The PRM system 102 may be used to monitor the operations of one or more such projects simultaneously.

The PRM system 102 may be implemented in a variety of computing systems, such as a laptop computer, a desktop computer, a notebook, a workstation, a mainframe computer, a server, a network server, a cloud based system, mobile based computing system, and the like. It will be understood that the PRM system 102 may be accessed by users through one or more client devices 104-1, 104-2, 104-N, collectively referred to as client devices 104. Examples of the client devices 104 may include, but not be limited to, a desktop computer, a portable computer, a mobile phone, a handheld device, a workstation. The client devices 104 may be used by various stakeholders or end users of project management such as project manager, business heads, team leaders, and system administrators. As shown in the figure, such client devices 104 may be communicatively coupled to the PRM system 102 through a network 106 for facilitating one or more end-users to access and operate the PRM system 102.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the network 106 may include a variety of network devices, including routers, bridges, servers, computing devices, storage devices, etc.

In one implementation, the PRM system 102 may include a processor 108, a memory 110 coupled to the processor 108, and interfaces 112. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 may be configured to fetch and execute computer-readable instructions stored in the memory 110. The memory 110 can include any non-transitory computer-readable medium known in the art including, for example, volatile memory (e.g., RAM), and/or non-volatile memory (e.g., EPROM, flash memory, etc.).

The interface(s) 112 may include a variety of software and hardware interfaces, for example, a web interface, a graphical user interface, etc., allowing the PRM system 102 to interact with the client devices 104. Further, the interface(s) 112 may enable the PRM system 102 to communicate with other computing devices, The interface(s) 112 can facilitate multiple communications within a wide variety of networks and protocol types, including wired networks, for example LAN, cable, etc., and wireless networks such as WLAN, cellular, or satellite. The interface(s) 112 may include one or more ports for connecting a number of devices to each other or to another server.

In one example, the PRM system 102 may include subsystems 114 and data 116. In one embodiment, the subsystems 114 and the data 116 may be stored within the memory 110. In one example, the subsystems 114, amongst other things, may include routines, programs, objects, components, and data structures, which perform particular tasks or implement particular abstract data types. The subsystems 114 may also be implemented as, signal processor(s), state machine(s), logic circuitries, and/or any other device or component that can manipulate signals based on operational instructions. Further, the subsystems 114 can be implemented by one or more hardware components, by computer-readable instructions executed by a processing unit, or by a combination thereof.

In one implementation, the subsystems 114 may further include a project analysis subsystem 118, resource allocation subsystem 120, process automation subsystem 122, process optimizer subsystem 124, workbench generator 126, project monitor 128, report generation subsystem 130, and other subsystem(s) 132. The other subsystems 132 may perform various miscellaneous functionalities of the PRM system 102. It will be appreciated that such aforementioned subsystems may be represented as a single subsystem or a combination of different subsystems.

In one example, the data 116 serves, amongst other things, as a repository for storing data fetched, processed, received and generated by one or more of the subsystems 114. In one implementation, the data 116 may include, for example, automation rules repository 134, optimization rules repository 136, monitoring rules repository 138, and other data 140. In one embodiment, the data 116 may be stored in the memory 110 in the form of various data structures. Additionally, the aforementioned data can be organized using data models, such as relational or hierarchical data models. The other data 140 may be used to store data, including temporary data and temporary files, generated by the subsystems 114 for performing the various functions of the PRM system 102.

In some examples, the PRM system 102 may be connected either directly or over the communication network 106 to a bot repository 142. The bot repository 142 may be understood to be a store house of the bots and robotic resources that may be used to automate portions of the project and/or implement the various functionalities of the PRM system 102. In some examples, the bots may be routines, programs, objects, components, and data structures, which perform particular tasks or implement particular abstract data types. The bots may also be implemented as signal processor(s), state machine(s), logic circuitries, and/or any other device or component that manipulate signals based on operational instructions. Further, the bots can be implemented by one or more hardware components, by computer-readable instructions executed by a processing unit, or by a combination thereof. In some examples, the bot repository 142 includes automation bots 144, optimization bots 146, monitoring bots 148, analysis and allocation (A&A) bots 150.

In some examples, the PRM system 102 may include an intelligent project operations subsystem 152. The intelligent project operations subsystem 152 may be understood to be structurally and functionally similar to the subsystems 114. In some examples, the intelligent project operations subsystem 152 may act as the interface between the subsystems 114, the processor 108, and the data 116. The working of the intelligent project operations subsystem 152 is described in greater detail in conjunction with the subsystems 114.

In operation, the project analysis subsystem 118 may obtain a project specification of a project from a client. In some examples, the project analysis subsystem 118 may generate various interfaces to facilitate the project manager to provide the project specification as an input. In other examples, the project analysis subsystem 118 may retrieve the project specification from a data repository. As mentioned earlier, the project specification may be a comprehensive description of objectives for the project, provided as structured or unstructured data. The project specification may include the goals, functionality, and details required for the project team to fulfill the requirements of the client. Also, in this description, the client may be understood to be a third party organization or a division of the organization itself, e.g., an internal client.

On obtaining the project specification, the project analysis subsystem 118 may analyze the project specification and identify the technical and business requirements and objectives of the project. In some examples, the project analysis subsystem 118 may generate various interfaces to facilitate the project manager to validate the technical and business requirements and objectives of the project and to modify the same as per his/her discretion. In some examples, the project analysis subsystem 118 may implement various techniques of natural language processing to process the project specification and generate the reports of technical and business requirements and objectives of the project, based on various pre-defined templates, e.g., provided by the project manager. In some examples, the project allocation subsystem 118 may activate the A&A bots 150 to implement various techniques of natural language processing, such as pattern matching, syntactically driven parsing, semantic grammars, case-frame instantiation, to process the project specification and generate the reports of technical and business requirements and objectives of the project. In some examples, the project analysis subsystem 118 may generate various interfaces to facilitate the project manager to edit the reports, generated based on the templates, for any modification that he may deem fit. In some examples, the intelligent project operations subsystem 152 may control the scenarios in which the project analysis subsystem 118 may choose to activate the A&A bots 150 or may choose for manual inputs from the project manager. For example, the intelligent project operations subsystem 152 may determine that in the case of the healthcare domain, the A&A bots 150 may be specifically error prone or the accuracy of the A&A bots 150 may be lower as compared to projects of other domains. In such cases, the intelligent project operations subsystem 152 may instruct the project analysis subsystem 118 to prompt the project manager to provide the technical and business objectives of the project and not to activate the A&A bots 150.

In a sequential or parallel operation, the resource allocation subsystem 120 may analyze the technical and business requirements and objectives of the project and generate a resource allocation model for fulfilling the project specification. In some embodiments, the resource allocation model, generated by the resource allocation subsystem 120, may comprise a plurality of resource entities allocated to the project for fulfilling the project specification. As mentioned earlier, these resource entities may be human resources or may be robotic resources such as specially programmed computer, embedded systems, and bots. In some embodiments, the bots may be software applications that operate as agents for a user or another software application, or simulate a human activity. In other embodiments, bots may be specialized software applications that execute automated tasks. In some examples, the resource allocation model, generated by the resource allocation subsystem 120, may be indicative of the hierarchical arrangement of a plurality of resource entities assigned to the project. For example, the resource allocation subsystem 120 may arrange the human resources into a plurality of levels, such as project engineers, senior project engineers, team leaders, project managers and so on. Each level of the human resources may be associated with a set of roles and responsibilities. In one example, the resource allocation subsystem 120 may generate the hierarchical arrangement of a plurality of resource entities based on the competency index associated with each of the resource entities. In some examples, the resource allocation subsystem 120 may also compute the competency index associated with each of the resource entities. For example, in case of human resources, the resource allocation model may generate the competency index of the resource entity based on various competency parameters, such as domain knowledge, educational qualifications, years of experience, certifications, and project experience. To compute the competency index, the resource allocation subsystem 120 may assign a weightage parameter to each of the competency parameters and compute a weighted mean of the competency parameters as the competency index. In some examples, the weightage parameter of each of the competency parameters may be based on the organizational policies or may be decided by the project manager.

Similarly, in the case of robotic resources, the resource allocation subsystem 120 may compute the competency index based on various competency parameters, such as programming language of the robotic resource, platform of the robotic resource, domain to which the robotic resource pertains, algorithm efficiency of the robotic resource and the resource usage, in terms of processing power and memory space, of the of the robotic resource. The competency index of the resource entity may be indicative of the suitability of the resource entity in the project. In some examples, the resource allocation subsystem 120 may design the resource allocation model, such that a role is assigned to at least one resource entity in the resource allocation model. For example, a first resource entity may be assigned as a software tester, a second resource entity may be assigned as a lead developer and so on. Thus, the resource allocation model may indicate a hierarchical arrangement of the resource entities that have been allocated or assigned to the project.

In some examples, the resource allocation subsystem 120 may also activate the A&A bots 150 to execute the allocation rules to determine whether a particular task in a project is to be assigned to a human resource or a robotic resource, such as a bot. Table 1 below shows some examples of allocation rules. The allocation rules which specifically deal with assignment of robotic resources for tasks may be referred to as bot allocation rules.

TABLE 1

| | |
|---|---|
| Rule 1 | If <application to be built is mobile application for travel |
| | reservation> & <travel backend application exists in the |
| | enterprise software, such as SAP> |
| | Then use “Application Programming Interface (API) Bot” |
| | Else assign a senior software developer |
| Explanation | In this case, the resource allocation subsystem 120 |
| of Rule 1 | automates the task of creating a mobile application for |
| | travel reservations on determining that the backend support |
| | for the travel application exists at the backend. If the |
| | resource allocation subsystem 120 determines that the |
| | backend support is non-existent, the resource allocation |
| | subsystem 120 will allocate a human resource, such as a |
| | senior software developer, for developing the mobile |
| | application. |
| Rule 2 | If <allocated bot has an implementation success ratio of less |
| | than 90%> |
| | Then override bot allocation and assign a software |
| | developer |
| Explanation | In this case, if the resource allocation subsystem 120 |
| of Rule 2 | determines that a bot can be assigned for a particular task, |
| | then it also determines the previous success ratio of the |
| | bot in implementing the same or similar tasks. In case, the |
| | implementation success ratio of the bot is less than a pre- |
| | defined threshold, say 90%, then the resource allocation |
| | subsystem 120 overrides the bot allocation and instead |
| | assigns a human resource, such as a software developer. |

In some examples, based on allocation rules, the resource allocation subsystem 120 may assign repetitive tasks to robotic resources and assign tasks that involve more autonomous decision making to human resources, such as choice of functions to be used or algorithms to be used for a task.

In some examples, the intelligent project operations subsystem 152 may control the scenarios in which the resource allocation subsystem 120 may allocate the resources using the A&A bots 150. For example, the intelligent project operations subsystem 152 may ascertain, from historical data, that the resource allocation subsystem 120 has particularly generated resource allocation model which have not been suitable as per the feedback of the project managers. In such a scenario, the intelligent project operations subsystem 152 may instruct the resource allocation subsystem 120 to inform the project manager of the same and prompt him to either generate the resource allocation model based on his inputs or modify the resource allocation model, generated by the resource allocation subsystem 120, as per his discretion.

In a parallel or sequential operation, the process automation subsystem 122 may identify one or more phases of the project capable of being automated, based on analysis of the project specification. In one example, the process automation subsystem 122 may retrieve automation rules from the automation rules repository 134, and execute the rules to identify the phases of the project that may be automated. In some examples, the process automation subsystem 122 may identify the phases of the project that are capable of being automated, based on one or more of cognitive analysis rules, continuous integration rules, and bots allocation rules.

In some examples, the process automation subsystem 122 may activate the automation bots 144 for executing the automation rules same to identify the phases of the project that may be automated. The automation bots 144 may implement the cognitive analysis rules, continuous integration rules, and bots allocation rules to identify the phases of the project that are capable of being automated.

In some examples, the intelligent project operations subsystem 152 may control the scenarios in which the process automation subsystem 122 may automate the phases of the project using the automation bots 144. In some examples, the intelligent project operations subsystem 152 may provide various insights of the functioning of the process automation subsystem 122 with respect to projects of different domains. Based on the insights, the process automation subsystem may inform the project manager of the insights, and prompt him to either generate or select the phases of the project to be automated, or modify the phases selected by the process automation subsystem 122 for automation.

Thereafter, the workbench generator 126 may modify at least one or more portions of a pre-existing workbench associated with a resource entity or may generate a new workbench for a resource entity based on at least one of the resource allocation model, the assigned role, and the identified phases of the project. For example, the workbench generator 126 may analyze the project specification and determine that the task of generating pseudo code may be automated and may be assigned to a bot. Based on the analysis, the workbench generator 126 may modify portions of the workbench, associated with a software engineer, to incorporate the automation of pseudo code generation in the work assigned to the software engineer. In another example, the workbench generator 126 may modify portions of the workbench, associated with a software engineer, to incorporate the automation of formatting of source code to various coding standards, specified by the client or the organization.

In a parallel or sequential operation, the project monitor 128 may ascertain the processes associated with the project based on analysis of the project specification or a business process model associated with the project specification. The project monitor 128 may identify those processes, from amongst the processes associated with the project, which have an effectiveness index less than a pre-defined threshold level. In some example, the project monitor 128 may monitor, at regular time intervals or on demand (e.g., by the project manager), whether the processes associated with the project have an effectiveness index that is equal to or greater than the pre-defined threshold level. In some examples, the project monitor 128 may monitor the processes of the project based on monitoring rules, retrieved from monitoring rules repository 138. The monitoring rules may be indicative if the parameters, such as resource consumption, error-rate, and output volume, rate of production, of the processes and resources that are to be monitored. In some examples, the project monitor 128 may activate monitoring bots 148 to monitor the processes associated with the project based on analysis of the project specification or a business process model associated with the project specification. The monitoring bots 148 may measure the various parameters, such as resource consumption, error-rate, and output volume, rate of production, of the processes and resources that are to be monitored.

If the project monitor 128 determines that one or more processes have an effectiveness index less than the pre-defined threshold level, then the process optimizer subsystem 124, either in an automated manner or based on inputs provided by the project manager, may apply process optimization techniques to amend the processes so as to enhance the effectiveness index of the automated processes above the pre-defined threshold level. In some examples, the process optimizer subsystem 124 may retrieve process optimization rules, from the optimization rules repository 136, for optimizing the identified processes.

Based on the amendment of the processes, the process optimizer subsystem 124 may modify one or more of the resource allocation subsystem or modify one or more workbenches associated with the resource entities to implement the amended processes. In some examples, the process optimizer subsystem 124 may activate the optimization bots 146 to modify one or more of the resource allocation subsystem or modify one or more workbenches associated with the resource entities to implement the amended processes.

In some examples, the report generation subsystem 130 may generate a project status index indicative of the status of the project. The status of the project may include details of phases of the project which have been completed, are in progress, and are to be worked on. The project status may provide all stakeholders associated with the project with a holistic view of the progress of the project. Further, the project status report may provide visibility to the management of the organization regarding the degree of completeness of the project, and the estimated time required to complete the project. The project status report may also help to identify whether the project has deviated from its planned path, and facilitate the stakeholders to align the project with the planned project path. The project status index may also be indicative of whether the project is on schedule or has to be provided more resources to complete the project on schedule.

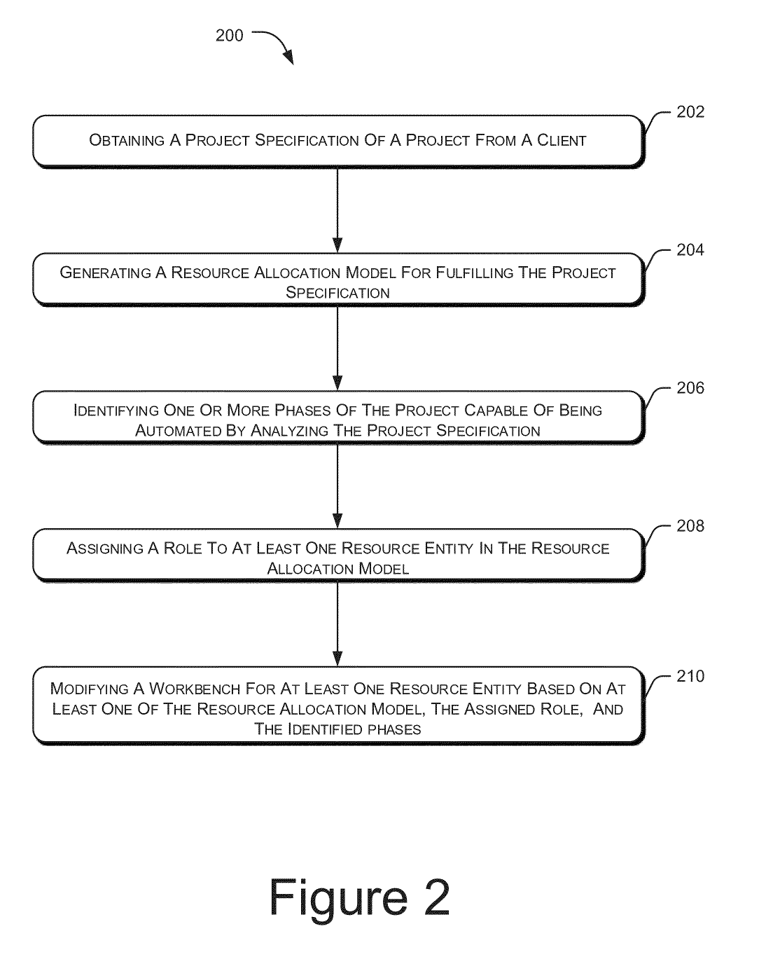

Thus, the PRM system 102 may manage operations in a project management model by identifying the phases of the project that may be automated and thereafter automating the same. This may reduce the human resources that have to be associated with a project for fulfilling the project specification. This may lead to lower costs of human resources, lowered probability of manual errors, and may ensure consistent quality across various processes of the project. Further, the PRM system 102 may monitor the performance of the processes associated with the project, identify the processes that are less effective than a pre-defined threshold level, and optimize the identified processes using process optimization so as to increase the effectiveness of the processes. This may lead to overall enhancement of efficiency and productivity of the project, leading to lower costs, lower error rates and higher profits. The detailed working of the PRM system 102 is further explained in conjunction with the FIGS. 2-4.

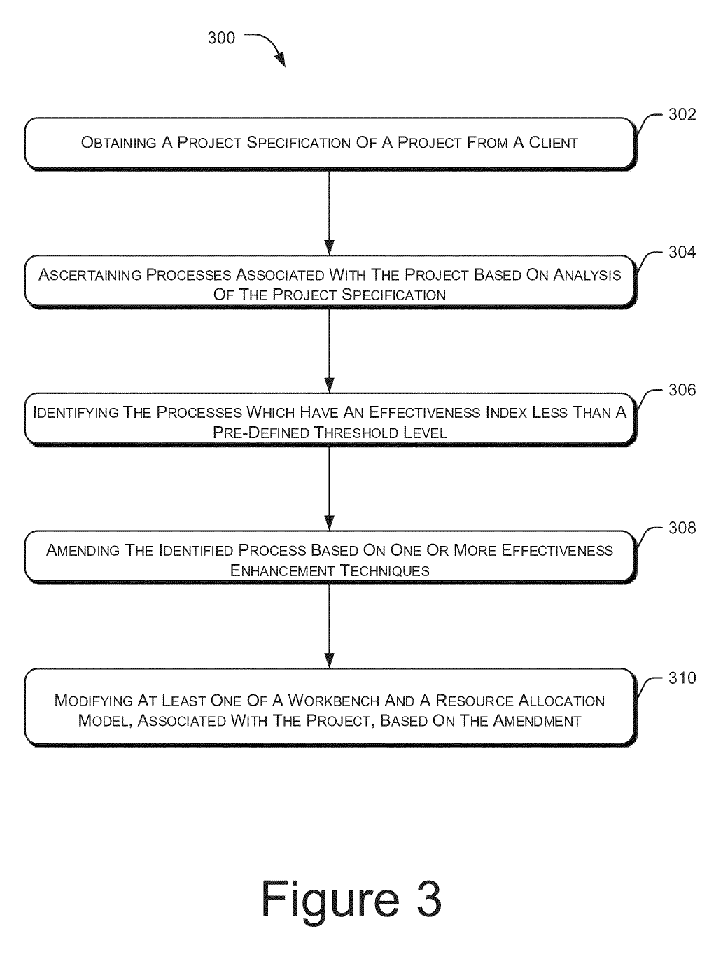

FIGS. 2 and 3 illustrate exemplary computer methods 200 & 300 for managing resources in a project management model, according to some embodiments of the present subject matter. The methods 200 and 300 may be described in the general context of computer executable instructions. Generally, computer executable instructions can include routines, programs, objects, components, data structures, procedures, subsystems, and functions, which perform particular functions or implement particular abstract data types. The methods 200 and 300 may also be practiced in a distributed computing environment where functions are performed by remote processing devices that are linked through a communication network. In a distributed computing environment, computer executable instructions may be located in both local and remote computer storage media, including memory storage devices.

The order in which the methods 200 and 300 is described is not intended to be construed as a limitation, and any number of the described method blocks can be combined in any order to implement the methods 200 and 300 or alternative methods. Additionally, individual blocks may be deleted from the methods 200 and 300 without departing from the spirit and scope of the subject matter described herein. Furthermore, the methods 200 and 300 can be implemented in any suitable hardware, software, firmware, or combination thereof.

With reference to method 200 as depicted in FIG. 2, as shown in block 202, a project specification of a project, from a client, obtained. In some examples, the project analysis subsystem 118 may obtain the project specification of a project. The project analysis subsystem 118 may generate various interfaces to facilitate the project manager to provide the project specification as an input. In some examples, the project analysis subsystem 118 may retrieve the project specification from a data repository.

As illustrated in block 204, a resource allocation model may be generated for fulfilling the project specification. In some examples, the resource allocation subsystem 120 may analyze the technical and business requirements and objectives of the project and generate a resource allocation model for fulfilling the project specification. In some embodiments, the resource allocation model, generated by the resource allocation subsystem 120 may comprise a plurality of resource entities allocated to the project for fulfilling the project specification. As mentioned earlier, these resource entities may be human resources or may be robotic resources, such as specially programmed computers, embedded systems, and bots.

As depicted in block 206, one or more phases of the project, capable of being automated, may be identified by analyzing the project specification. In some examples, the process automation subsystem 122 may identify one or more phases of the project capable of being automated, based on analysis of the project specification. In one example, the process automation subsystem 122 may retrieve automation rules from the automation rules repository 134, and execute the rules to identify the phases of the project that may be automated.

At block 208, a role may be assigned in the resource allocation model to at least one resource entity. In some examples, the resource allocation subsystem 120 may design the resource allocation model, such that a role is assigned to at least one resource entity in the resource allocation model.

As shown in block 210, a workbench, for at least one resource entity, may be modified based on at least one of the resource allocation model, the assigned role, and the identified phases. In some examples, the workbench generator 126 may modify at least one or more portions of a pre-existing workbench associated with a resource entity or may generate a new workbench for a resource entity based on at least one of the resource allocation model, the assigned role, and the identified phases of the project.

With reference to method 300 as depicted in FIG. 3, at block 302, a project specification of a project, from a client, may be obtained. In some examples, the project analysis subsystem 118 may obtain the project specification of a project. The project analysis subsystem 118 may generate various interfaces to facilitate the project manager to provide the project specification as an input. In some examples, the project analysis subsystem 118 may retrieve the project specification from a data repository.

As illustrated in block 304, the processes, associated with the project, may be ascertained based on analysis of the project specification. In some examples, the project monitor 128 may ascertain the processes associated with the project based on analysis of the project specification or a business process model associated with the project specification.

As depicted in block 306, the processes, which have an effectiveness index less than a pre-defined threshold level, may be identified. In some examples, the project monitor 128 may monitor, at regular time intervals or on demand, whether the processes associated with the project have an effectiveness index that is equal to or greater than the pre-defined threshold level. In some examples, the project monitor 128 may monitor the processes of the project based on monitoring rules, retrieved from monitoring rules repository 138. Thereafter, the project monitor 128 may identify the processes that have an effectiveness index less than a pre-defined threshold level.

As shown in block 308, the identified process may be amended based on one or more process optimization techniques. In one example, the process optimizer subsystem 124, either in an automated manner or based on inputs provided by the project manager, may apply process optimization techniques to amend the processes so as to enhance the effectiveness index of the automated processes above the pre-defined threshold level. In some examples, the process optimizer subsystem 124 may retrieve process optimization rules, from the optimization rules repository 136, for optimizing the identified processes.

At block 310, at least one of a workbench and a resource allocation model, associated with the project, may be modified based on the amendment. In some examples, based on the amendment of the processes, the process optimizer subsystem 124 may modify one or more of the resource allocation subsystem or modify one or more workbenches associated with the resource entities to implement the amended processes.

### Computer System

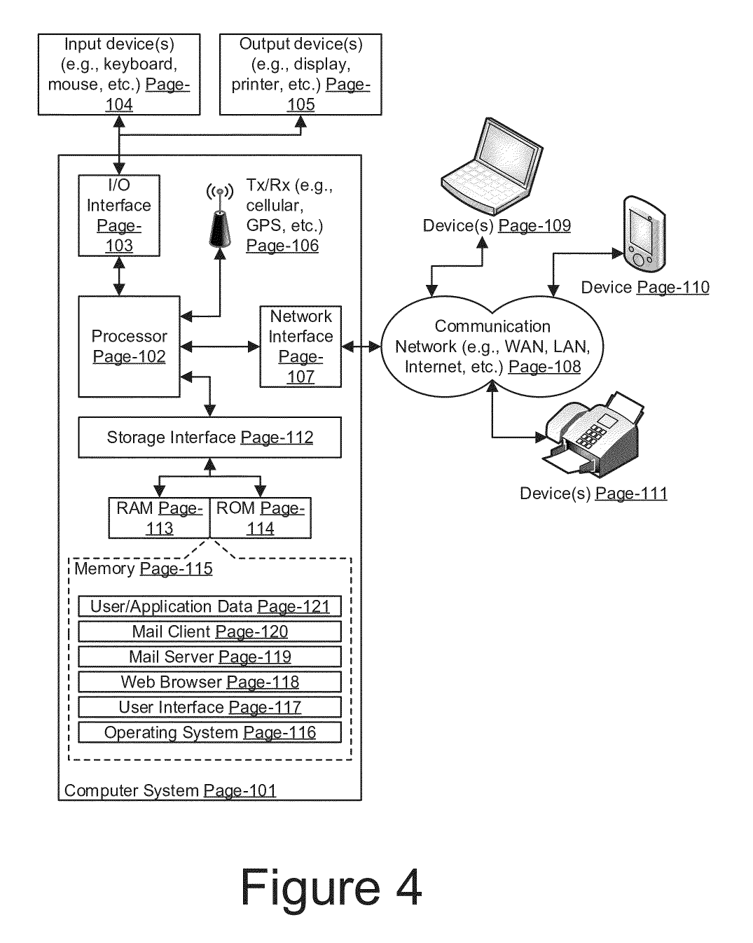

FIG. 4 is a block diagram of an exemplary computer system for implementing embodiments consistent with the present disclosure. Variations of computer system 401 may be used for implementing any of the devices presented in this disclosure. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 418-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 407 may communicate with the communication network 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 410, 411, and 412. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 401 may itself embody one or more of these devices.

In some embodiments, the processor 402 may be disposed in communication with one or more memory devices (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described a method and a system for managing resources in a project management model. The illustrated steps are set out to explain the exemplary embodiments shown, and it should be anticipated that ongoing technological development may change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A computer-implemented resource management method, comprising:
generating, based on a project specification, a resource allocation model indicative of a hierarchical arrangement of a plurality of robotic resource entities;
determining, by the resource allocation model, a plurality of competency parameters associated with one or more of the plurality of robotic resource entities and a competency index for the one or more robotic resource entities based on corresponding plurality of competency parameters;
identifying one or more project phases capable of being automated, by analyzing the project specification using a parser and natural language processor, wherein the project specification comprises unstructured data;
initiating computational processing for automating the identified one or more project phases; and
generating a modified workbench for at least one of the robotic resource entities based on the resource allocation model and the automated one or more project phases.

2. The method of claim 1, wherein identifying further comprises using one or more automation rules comprising at least one of: cognitive analytics rules, continuous integration rules, or bot implementation rules on the project specifications.

3. The method of claim 1, wherein the method further comprises:
assigning a role for at least one of the robotic resource entities associated with the resource allocation model; and
assigning one or more project tasks to that at least one robotic resource entity based on the assigned role.

4. The method of claim 1 further comprising:
determining whether a project task is to be assigned to one of a robotic resource and a human resource;
ascertaining an implementation success ratio of the robotic resource on the task to be assigned; and
overriding allocation of the task to the robotic resource on ascertaining the implementation success ratio to be below a pre-defined threshold.

5. The method of claim 1, wherein the method further comprises:
identifying one or more project-related processes having an effectiveness index less than a pre-defined threshold;
modifying the identified one or more project-related processes based on at least one of: lean techniques or six sigma techniques, wherein modifying the identified one or more project-related processes increases the effectiveness index to equal or exceed the pre-defined threshold; and
modifying the resource allocation model in response to modifying the identified one or more project-related processes.

6. A project resource management system, comprising:
one or more hardware processors;
one or more memory units communicatively coupled to the one or more processors, wherein the one or more memory units store processor-executable instructions, which, on execution, cause the one or more processors to perform acts comprising:
generating, based on a project specification, a resource allocation model indicative of a hierarchical arrangement of a plurality of robotic resource entities;
determining, by the resource allocation model, a plurality of competency parameters associated with one or more of the plurality of robotic resource entities and a competency index for the one or more robotic resource entities based on corresponding plurality of competency parameters;
identifying one or more project phases capable of being automated, by analyzing the project specification using a parser and natural language processor, wherein the prosect specification comprises unstructured data;
initiating computational processing for automating the identified one or more project phases; and
generating a modified workbench for at least one of the robotic resource entities based on the resource allocation model and the automated one or more project phases.

7. The system of claim 6, wherein the instructions, on execution, further cause the processor to perform acts comprising using one or more automation rules comprises at least one of: cognitive analytics rules, continuous integration rules, or bot implementation rules.

8. The system of claim 6, wherein the instructions, on execution, further cause the processor to perform acts comprising:
assigning a role for at least one of the robotic resource entities associated with the resource allocation model; and
assigning one or more project tasks to that at least one robotic resource entity based on the assigned role.

9. The system of claim 6, wherein the instructions, on execution, further cause the processor to perform acts comprising:
determining whether a project task is to be assigned to one of a robotic resource and a human resource;
ascertaining an implementation success ratio of the robotic resource on the task to be assigned; and
overriding allocation of the task to the robotic resource on ascertaining the implementation success ratio to be below a pre-defined threshold.

10. The system of claim 6, wherein the instructions, on execution, further cause the processor to perform acts comprising:
identifying one or more project-related processes having an effectiveness index less than a pre-defined threshold;
modifying the identified one or more project-related processes based on at least one of: lean techniques or six sigma techniques, wherein modifying the identified one or more project-related processes increases the effectiveness index to equal or exceed the pre-defined threshold; and
modifying the resource allocation model in response to modifying the identified one or more project related processes.

11. A non-transitory computer-readable device, storing computer-executable resource management instructions, comprising instructions for:
generating, based on a project specification, a resource allocation model indicative of a hierarchical arrangement of a plurality of robotic resource entities;
determining, by the resource allocation model, a plurality of competency parameters associated with one or more of the plurality of robotic resource entities and a competency index for the one or more robotic resource entities based on corresponding plurality of competency parameters;
identifying one or more project phases capable of being automated, by analyzing the project specification using a parser and natural language processor, wherein the project specification comprises unstructured data;
initiating computational processing for automating the identified one or more project phases; and
generating a modified workbench for at least one of the robotic resource entities based on the resource allocation model and the automated one or more project phases.

12. The device of claim 11, wherein identifying further comprises using one or more automation rules comprises at least one of: cognitive analytics rules, continuous integration rules, or bot implementation rules.

13. The device of claim 11, the resource management instructions further comprising instructions for:
assigning a role for at least one of the robotic resource entities associated with the resource allocation model; and
assigning one or more project tasks to that at least one robotic resource entity based on the assigned role.

14. The device of claim 11, the resource management instructions further comprising instructions for:
determining whether a project task is to be assigned to one of a robotic resource and a human resource;
ascertaining an implementation success ratio of the robotic resource on the task to be assigned; and
overriding allocation of the task to the robotic resource on ascertaining the implementation success ratio to be below a pre-defined threshold.

15. The device of claim 11, the resource management instructions further comprising instructions for:
identifying one or more project-related processes having an effectiveness index less than a pre-defined threshold;
modifying the identified one or more project-related processes based on at least one of: lean techniques or six sigma techniques, wherein modifying the identified one or more project-related processes increases the effectiveness index to equal or exceed the pre-defined threshold; and
modifying the resource allocation model in response to modifying the identified one or more project related processes.

16. The method of claim 1, wherein the project specification is a raw unstructured data file that identifies technical requirements of a project.

17. The method of claim 16, wherein the parser and the natural language processor use an electronic dictionary to correlate key words from the raw unstructured data file with fields in a predefined data model and match the one or more project phases with the predefined data model.

18. The method of claim 1, wherein generating the modified workbench comprises uninstalling at least one software component on a computer utilized by at least one of the robotic resource entities.
